(19) United States
(12) Patent Application Publication
(10) Pub. No.: US 2026/0008489 A1
(43) Pub. Date: Jan. 8, 2026

(54) Collapsible wagon and wagon with height reduced after being folded

(71) Applicant: Jinhua Mutao Leisure Products Co., Ltd., Jinhua (CN)

(72) Inventor: Xiangshan ZHANG, Suzhou (CN)

(73) Assignee: Jinhua Mutao Leisure Products Co., Ltd., Jinhua (CN)

(21) Appl. No.: 18/811,757

(22) Filed: Aug. 21, 2024

(30) Foreign Application Priority Data
Jul. 2, 2024 (CN) 202410878261.7
Jul. 2, 2024 (CN) 202421544737.5

(51) Int. Cl. B62B 3/02; B62B 5/06

(52) U.S. Cl. CPC B62B 3/02; B62B 5/065

(57) ABSTRACT

A collapsible wagon includes four standing posts, a bottom folding mechanism, a first folding mechanism, a third folding mechanism, a second folding mechanism, a fourth folding mechanism, and first sliding sleeves, where the first sliding sleeves are respectively slidably provided on the standing posts, and are respectively hinged to short tubes. Each of the first and second folding mechanisms includes a first crossing assembly, at least one third crossing assembly, and a second crossing assembly that are hinged in sequence; each of the first and second crossing assemblies includes a first cross tube and a second cross tube; the first cross tube is hinged to an upper end of the corresponding standing post; the short tube is hinged to the first cross tube and provided with a second sliding sleeve; the second cross tube is hinged to the second sliding sleeve of the corresponding short tube.

### CROSS REFERENCE TO THE RELATED APPLICATIONS

This application is based upon and claims priority to Chinese Patent Applications No. 202421544737.5 and 202410878261.7, both filed on Jul. 2, 2024, the entire contents of which are incorporated herein by reference.

### TECHNICAL FIELD

The present disclosure relates to the technical field of wagons, and in particular to a collapsible wagon and a wagon with a reduced height after being folded.

### BACKGROUND

In daily life and production, it is often necessary to use wagons to transport luggage or items. Wagons are widely used because they are convenient, time-saving, and effortless to push. Collapsible wagons are designed for easy storage. Collapsible wagons are lightweight and can be placed on the vehicle after being folded, making them easy to carry.

However, the existing collapsible wagon has a small capacity after being unfolded, only to store a small number of items, and has a large volume and takes up a lot of space after being folded. It is especially inconvenient to fold and store the collapsible wagon in a space-limited area such as a car trunk, seriously affecting the user experience.

### SUMMARY

### (I) Technical Problem to Be Solved

In view of the above defects and shortcomings of the prior art, the present disclosure provides a collapsible wagon and a wagon with a height reduced after being folded. The present disclosure solves the technical problem that the existing collapsible wagon has a small unfolded capacity and a large folded volume.

### (II) Technical Solution

In order to achieve the above objective, the present disclosure provides a collapsible wagon, including four standing posts arranged in a rectangle pattern and at intervals, a bottom folding mechanism hinged between the four standing posts, a first folding mechanism, a third folding mechanism, a second folding mechanism, and a fourth folding mechanism that are arranged in sequence and respectively connected between adjacent two standing posts, and first sliding sleeves respectively slidably provided on the standing posts, where the first sliding sleeves are respectively hinged to short tubes;
each of the first folding mechanism and the second folding mechanisms includes a first crossing assembly, at least one third crossing assembly, and a second crossing assembly that are hinged in sequence; each of the first crossing assembly and the second crossing assembly includes a first cross tube and a second cross tube; the first cross tube is hinged to an upper end of the corresponding standing post, and the short tube is hinged to the first cross tube; the short tube is provided with a second sliding sleeve; and the second cross tube is hinged to the second sliding sleeve of the corresponding short tube; and
folded heights of the first crossing assembly, the third crossing assembly, the second crossing assembly, the third folding mechanism, the fourth folding mechanism and the bottom folding mechanism are not greater than a height of the upper end of the standing post.

Optionally, each of the first folding mechanism and the second folding mechanism includes the first crossing assembly, the third crossing assembly, and the second crossing assembly that are hinged in sequence.

Optionally, the collapsible wagon further includes a first suspension rod and a second suspension rod;
an upper end of the first suspension rod is hinged to the first folding mechanism; an upper end of the second suspension rod is hinged to the second folding mechanism; and a lower end of the first suspension rod and a lower end of the second suspension rod are connected to the bottom folding mechanism; and
the first suspension rod and the second suspension rod are flexible rods; and in a process of folding the collapsible wagon, the first suspension rod and the second suspension rod deform, and the two ends of the first suspension rod respectively approach the two ends of the second suspension rod.

Optionally, the bottom folding mechanism includes a first bottom support assembly and a second bottom support assembly that are symmetrically arranged and hinged to each other; and each of the first bottom support assembly and the second bottom support assembly includes a first bottom connector, a first bottom connecting tube, a second bottom connecting tube, a third bottom connecting tube, and a fourth bottom connecting tube;
first ends of the first bottom connecting tube, the second bottom connecting tube, the third bottom connecting tube and the fourth bottom connecting tube are rotatably connected at a limited angle to the first bottom connector; and
second ends of the first bottom connecting tube and the second bottom connecting tube are respectively rotatably connected at a limited angle to lower ends of corresponding standing posts.

Optionally, the bottom folding mechanism further includes a second bottom connector and a third bottom connector that are symmetrically arranged; and the lower end of the first suspension rod and the lower end of the second suspension rod are respectively connected to the second bottom connector and the third bottom connector;
the third bottom connecting tube of the first bottom support assembly and the third bottom connecting tube of the second bottom support assembly are rotatably connected at a limited angle to the third bottom connector; and
the fourth bottom connecting tube of the first bottom support assembly and the fourth bottom connecting tube of the second bottom support assembly are rotatably connected at a limited angle to the second bottom connector.

Optionally, the four standing posts are a first standing post, a second standing post, a third standing post, and a fourth standing post, respectively;
each of the third folding mechanism and the fourth folding mechanism includes a first crossing tube and a second crossing tube that are hinged to each other, as well as a third crossing tube and a fourth crossing tube that are hinged to each other; first ends of the first crossing tube and the third crossing tube are hinged to each other; and first ends of the second crossing tube and the fourth crossing tube are hinged to each other;
in the fourth folding mechanism, a second end of the first crossing tube is hinged to an upper end of the fourth standing post, a second end of the third crossing tube is hinged to an upper end of the first standing post, a second end of the second crossing tube is hinged to the first sliding sleeve on the fourth standing post, and a second end of the fourth crossing tube is hinged to the first sliding sleeve on the first standing post; and
in the third folding mechanism, a second end of the first crossing tube is hinged to an upper end of the second standing post, a second end of the third crossing tube is hinged to an upper end of the third standing post, a second end of the second crossing tube is hinged to the first sliding sleeve on the second standing post, and a second end of the fourth crossing tube is hinged to the first sliding sleeve on the third standing post.

Optionally, the collapsible wagon further includes a handle mechanism;
the handle mechanism includes a telescopic rod, a first horizontal tube, a second horizontal tube, and a limiting member; and the telescopic rod is slidably connected to the limiting member; and
first ends of the first horizontal tube and the second horizontal tube are respectively rotatably connected at a limited angle to two ends of the limiting member; and second ends of the first horizontal tube and the second horizontal tube are respectively rotatably connected to lower ends of two standing posts connected to the fourth folding mechanism.

Furthermore, the present disclosure further provides a wagon with a height reduced after being folded, including lifting tubes and the collapsible wagon, where an end of the lifting tube is hinged to the second sliding sleeve, and the lifting tube is slidably connected to the upper end of the corresponding standing post; and upper ends of the four lifting tubes are configured to be respectively connected to four corners of a fabric bed of the wagon with a height reduced after being folded;
when the collapsible wagon changes from a folded state to an unfolded state, the upper ends of the lifting tubes move vertically away from the upper ends of the standing posts when a wagon frame is unfolded; and when the collapsible wagon changes from the unfolded state to the folded state, the upper ends of the lifting tubes vertically approach the upper ends of the standing posts when the wagon frame is folded; and
a height of the collapsible wagon in the folded state is smaller than a height of the collapsible wagon in the unfolded state, and the height of the collapsible wagon is reduced after the collapsible wagon is folded.

Optionally, the upper ends of the lifting tubes are respectively provided with connecting members, and the connecting members are respectively connected to the corners of the fabric bed of the collapsible wagon.

### (III) Beneficial Effects

Firstly, the short tube serves as an accessory structure, effectively increasing the lengths of the second cross tube and the first cross tube, thereby increasing the unfolded lengths of the first folding mechanism and the second folding mechanism. The design increases the capacity of the collapsible wagon unfolded while keeping the number of the crossing assemblies constant. If the volume of the collapsible wagon unfolded is increased by increasing the number of the crossing assemblies, it will increase the weight of the collapsible wagon and make it inconvenient for the transportation of the wagon vertically. Secondly, when the wagon is unfolded, the angle between the short tube and the standing post is smaller than the angle between the second cross tube and the standing post. To fold the wagon, the first sliding sleeve slides downward, and the second sliding sleeve slides towards the first end of the short tube. A smaller angle between the short tube and the standing post leads to a smaller angle between the direction of the force exerted by the short tube on the first sliding sleeve and the axial direction of the standing post. A greater force on the first sliding sleeve results in smoother sliding of the first sliding sleeve. Thirdly, the short tube reduces the angle between the short tube and the second cross tube. Similarly, the sliding of the second sliding sleeve is smoother, improving the smoothness of folding the wagon.

The folded heights of the first crossing assembly, the third crossing assembly, the second crossing assembly, the third folding mechanism, the fourth folding mechanism and the bottom folding mechanism are not greater than the height of the upper end of the standing post, ensuring that the folded height of the wagon does not increase, making it convenient for the user to store and carry the wagon.

### BRIEF DESCRIPTION OF THE DRAWINGS

FIG. 1 is a structural diagram of a collapsible wagon according to the present disclosure;

FIG. 2 is a three-dimensional diagram of the collapsible wagon according to the present disclosure;

FIG. 3 is a front view of the collapsible wagon according to the present disclosure;

FIG. 4 is a left view of the collapsible wagon according to the present disclosure;

FIG. 5 is a right view of the collapsible wagon according to the present disclosure;

FIG. 6 is a top view of the collapsible wagon according to the present disclosure;

FIG. 7 is a structural diagram of the collapsible wagon in a folded state according to the present disclosure;

FIG. 8 is a structural diagram of a wagon with a height reduced after being folded according to the present disclosure;

FIG. 9 is a front view of the wagon with a height reduced after being folded according to the present disclosure;

FIG. 10 is a left view of the wagon with a height reduced after being folded according to the present disclosure; and

FIG. 11 is a structural diagram of the wagon with a height reduced after being folded in a folded state according to the present disclosure.

### REFERENCE NUMERALS

1. standing post; 11. first standing post; 12. second standing post; 13. third standing post; and 14. fourth standing post;
2. bottom folding mechanism; 21. first bottom support assembly; and 22. second bottom support assembly;
210. first bottom connector; 211. first bottom connecting tube; 212. second bottom connecting tube; 213. third bottom connecting tube; 214. fourth bottom connecting tube; 216. second bottom connector; and 215. third bottom connector;
31. first folding mechanism; 32. second folding mechanism; 33. third folding mechanism; and 34. fourth folding mechanism;
311. first crossing assembly; 312. second crossing assembly; and 313. third crossing assembly;
3111. first cross tube; 3112. second cross tube; 3113. third cross tube; and 3114. fourth cross tube;
341. first crossing tube; 342. second crossing tube; 343. third crossing tube; and 344. fourth crossing tube;
41. first sliding sleeve; and 42. second sliding sleeve;
5. short tube;
6. handle mechanism; 60. telescopic rod; 61. first horizontal tube; 62. second horizontal tube; and 63. limiting member;
71. first suspension rod; and 72. second suspension rod;
8. caster; and
100. lifting tube; and 104. connecting member.

### DETAILED DESCRIPTION OF THE EMBODIMENTS

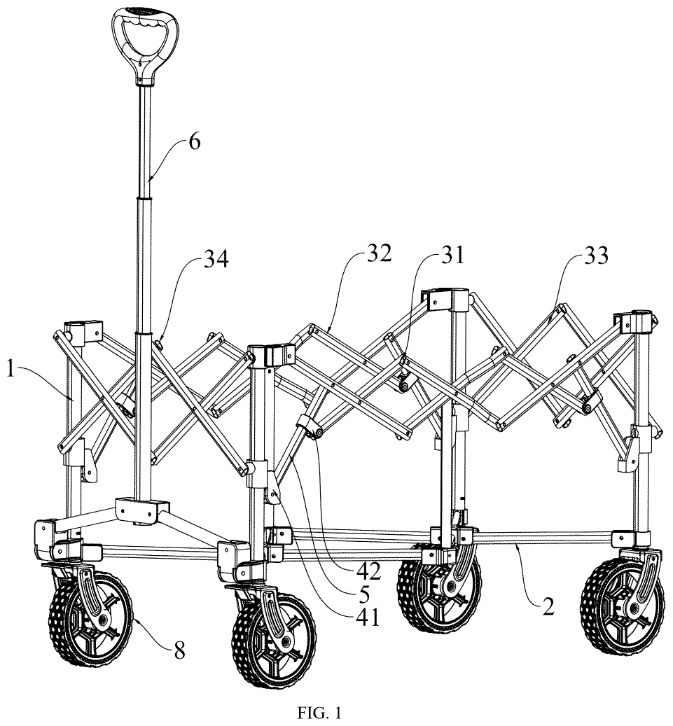

To facilitate a better understanding of the present disclosure, the present disclosure is described in detail below with reference to the drawings and specific embodiments. The terms such as “upper” and “lower” mentioned herein are based on the orientations shown in FIG. 1.

Although the drawings show exemplary embodiments of the present disclosure, it should be understood that the present disclosure may be implemented in various forms and should not be limited to the embodiments set forth herein. The embodiments are provided for a more thorough understanding of the present disclosure, so as to make the scope of the present disclosure be fully conveyed to those skilled in the art.

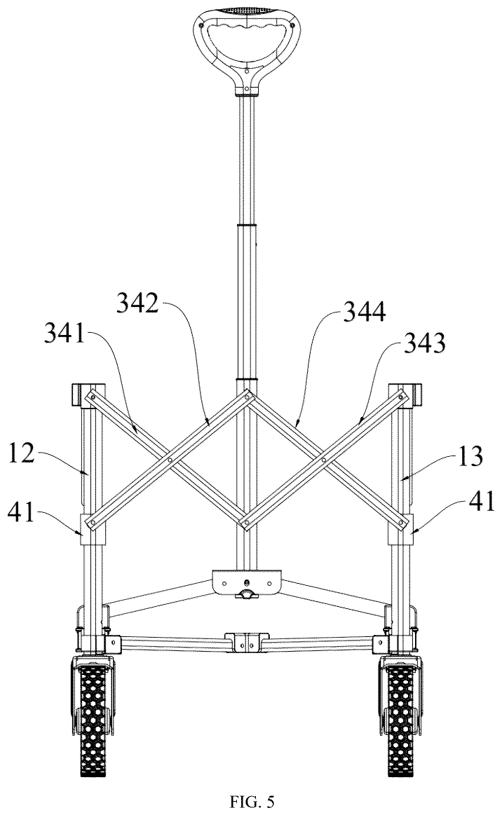

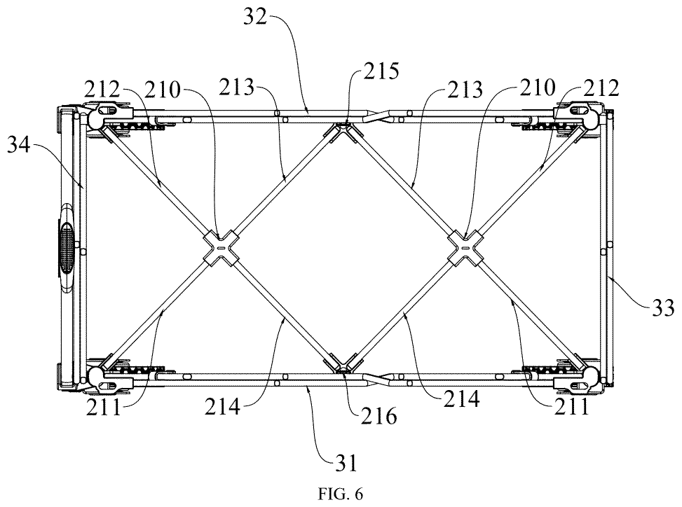

As shown in FIGS. 1 to 7, the present disclosure provides a collapsible wagon and a wagon with a height reduced after being folded. The collapsible wagon includes four standing posts 1 arranged in a rectangle pattern and at intervals, bottom folding mechanism 2 hinged between the four standing posts 1 through hinge points that are located at lower ends of the standing posts 1, first folding mechanism 31, third folding mechanism 33, second folding mechanism 32, and fourth folding mechanism 34 that are arranged in sequence and respectively connected between adjacent two standing posts 1, and first sliding sleeves 41 respectively slidably provided on the standing posts 1. The first sliding sleeves 41 are respectively hinged to short tubes 5. Furthermore, the four standing posts 1 are respectively first standing post 11, second standing post 12, third standing post 13, and fourth standing post 14. The standing posts 1 are slidably provided with the first sliding sleeves 41, respectively. The first sliding sleeves 41 each are hinged to one short tube 5, with a hinge point located at a first end of the short tube 5. The first folding mechanism 31 is connected between the first standing post 11 and the second standing post 12, the second folding mechanism 32 is connected between the third standing post 13 and the fourth standing post 14, the third folding mechanism 33 is connected between the second standing post 12 and the third standing post 13, and the fourth folding mechanism 34 is connected between the first standing post 11 and the fourth standing post 14.

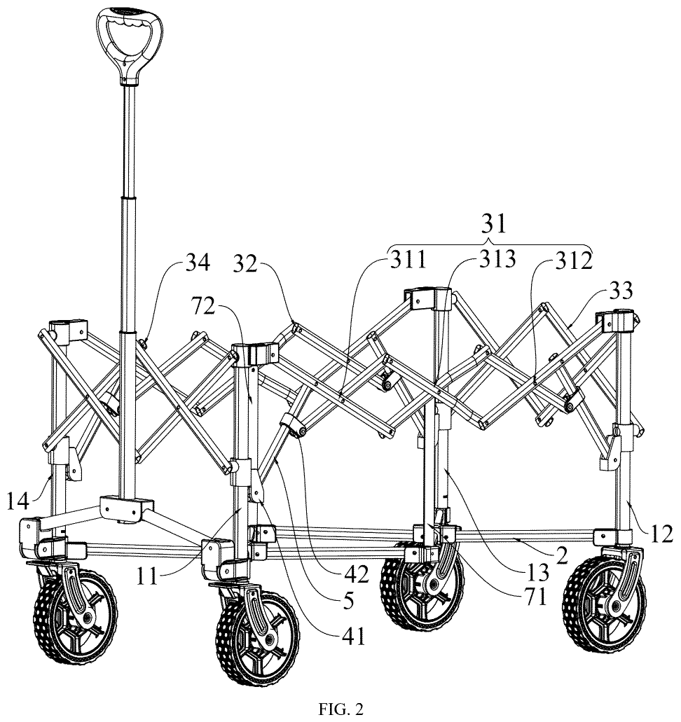

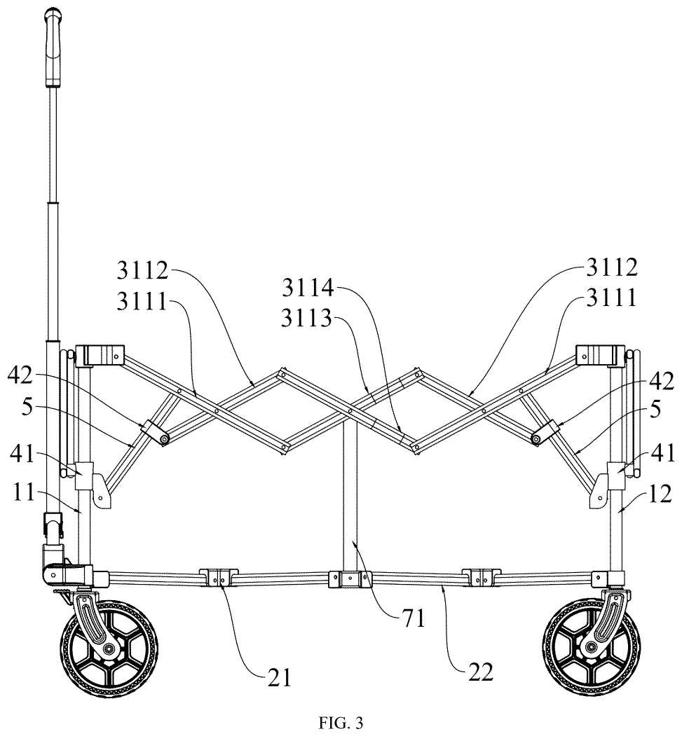

As shown in FIGS. 2 and 3, each of the first folding mechanism 31 and the second folding mechanism 32 includes first crossing assembly 311, third crossing assembly 313, and second crossing assembly 312 that are hinged in sequence. There may be one or more than one third crossing assembly 313. If there are multiple third crossing assemblies 313, the multiple third crossing assemblies are hinged in sequence. Each of the first crossing assembly 311 and the second crossing assembly 312 includes first cross tube 3111 and second cross tube 3112 that are hinged to each other, and the third crossing assembly 313 includes third cross tube 3113 and fourth cross tube 3114 that are hinged to each other. Two ends of the third cross tube 3113 are hinged to the first cross tube 3111 of the first crossing assembly 311 and the second cross tube 3112 of the second crossing assembly 312, respectively. Two ends of the fourth cross tube 3114 are hinged to the second cross tube 3112 of the first crossing assembly 311 and the first cross tube 3111 of the second crossing assembly 312, respectively. In the first crossing assembly 311 and the second crossing assembly 312, the first crossing assembly 311 and the second crossing assembly 312 have the same structure and symmetrical positions. The first cross tube 3111 of the first crossing assembly 311 is hinged to an upper end of the first standing post 11, and the first cross tube 3111 of the second crossing assembly 312 is hinged to an upper end of the second standing post 12. For example, in the first crossing assembly 311, a second end of the short tube 5 is hinged to a tube body of the first cross tube 3111 of the first crossing assembly 311. The short tube 5 is provided with second sliding sleeve 42. An end of the second cross tube 3112 of the first crossing assembly 311 is hinged to the second sliding sleeve 42 on the short tube 5.

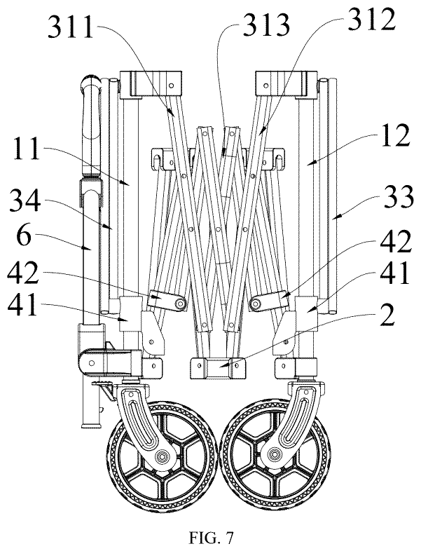

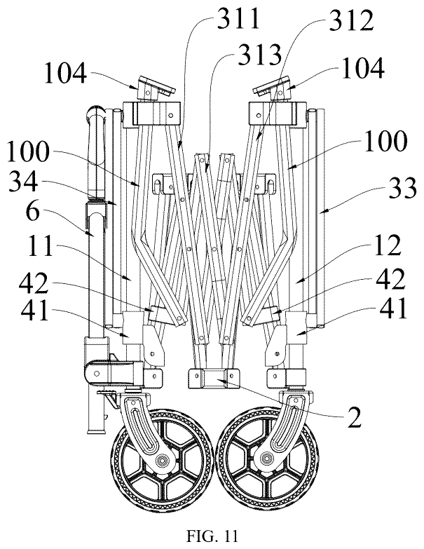

Firstly, the short tube 5 serves as an accessory structure, effectively increasing the lengths of the second cross tube 3112 and the first cross tube 3111, thereby increasing the unfolded lengths of the first folding mechanism 31 and the second folding mechanism 32. The design increases the capacity of the collapsible wagon unfolded while keeping the number of the crossing assemblies constant. If the volume of the collapsible wagon unfolded is increased by increasing the number of the crossing assemblies, it will increase the weight of the collapsible wagon and make it inconvenient for the transportation of the wagon vertically. Secondly, when the wagon is unfolded, the angle between the short tube 5 and the standing post 1 is smaller than the angle between the second cross tube 3112 and the standing post 1. To fold the wagon, the first sliding sleeve 41 slides downward, and the second sliding sleeve 42 slides towards the first end of the short tube 5. A smaller angle between the short tube 5 and the standing post 1 leads to a smaller angle between the direction of the force exerted by the short tube 5 on the first sliding sleeve 41 and the axial direction of the standing post 1. A greater force on the first sliding sleeve results in smoother sliding of the first sliding sleeve 41. Thirdly, the short tube 5 reduces the angle between the short tube 5 and the second cross tube 3112. Similarly, the sliding of the second sliding sleeve 42 is smoother, improving the smoothness of folding the wagon. Referring to FIGS. 7 and 11, the folded heights of the first crossing assembly 311, the third crossing assembly 313, the second crossing assembly 312, the third folding mechanism 33, the fourth folding mechanism 34 and the bottom folding mechanism 2 are not greater than the height of the upper end of the standing post 1, ensuring that the folded height of the wagon does not increase, making it convenient for the user to store and carry the wagon.

In a preferred implementation, each of the first folding mechanism 31 and the second folding mechanism 32 includes the first crossing assembly 311, the third crossing assembly 313, and the second crossing assembly 312 that are hinged in sequence. The design ensures that the wagon has a large unfolded capacity in addition to a small folded volume, improving the user experience.

As shown in FIGS. 2 and 3, the collapsible wagon further includes first suspension rod 71 and second suspension rod 72. An upper end of the first suspension rod 71 is hinged to the first folding mechanism 31, and an upper end of the second suspension rod 72 is hinged to the second folding mechanism 32. A lower end of the first suspension rod 71 and a lower end of the second suspension rod 72 are connected to front and rear sides of the bottom folding mechanism 2, respectively. When the collapsible wagon is in an unfolded state, it exerts an upward pulling force on the bottom folding mechanism 2, increasing the support force of the bottom folding mechanism 2. Moreover, the first suspension rod 71 and the second suspension rod 72 are flexible rods, and can even be slings such as cloth straps and steel cables. During the folding process of the collapsible wagon, the first suspension rod 71 and the second suspension rod 72 deform, and the two ends of the first suspension rod 71 respectively approach the two ends of the second suspension rod 72.

As shown in FIGS. 1 to 3 and 6, the bottom folding mechanism 2 includes first bottom support assembly 21 and second bottom support assembly 22 that are symmetrically arranged and hinged to each other. Each of the first bottom support assembly 21 and the second bottom support assembly 22 includes first bottom connector 210, first bottom connecting tube 211, second bottom connecting tube 212, third bottom connecting tube 213, and fourth bottom connecting tube 214. First ends of the first bottom connecting tube 211, the second bottom connecting tube 212, the third bottom connecting tube 213 and the fourth bottom connecting tube 214 of the first bottom support assembly 21 are rotatably connected at a limited angle to the first bottom connector 210 of the first bottom support assembly 21. First ends of the first bottom connecting tube 211, the second bottom connecting tube 212, the third bottom connecting tube 213 and the fourth bottom connecting tube 214 of the second bottom support assembly 22 are rotatably connected at a limited angle to the first bottom connector 210 of the second bottom support assembly 22. Specifically, for example, in the first bottom support assembly 21, the first bottom connector 210 is provided with four symmetrically arranged mounting slots. When the wagon is unfolded, a bottom of the mounting slot is horizontal, and open downward. The first end of each bottom connecting tube is located in the corresponding mounting slot and rotatably connected to an inner wall of the mounting slot. When each bottom connecting tube rotates upward relative to the first bottom connector 210 from a folded tilted state until a tube wall contacts the bottom of the mounting slot, each bottom connecting tube is restricted by the mounting slot and cannot continue to rotate, thus maintaining a horizontal state and providing effective support for the bottom of the wagon. Second ends of the first bottom connecting tube 211 and the second bottom connecting tube 212 are respectively rotatably connected at a limited angle to lower ends of corresponding standing posts 1. The structural form is similar to that of the first bottom connector 210, except for the only difference that the mounting slot is open upward to restrict the first bottom connecting tube 211 and the second bottom connecting tube 212 such that they can only rotate downward relative to the mounting slot at the lower end of the standing post 1 from the folded tilted state to the horizontal state.

Furthermore, as shown in FIGS. 1, 2, and 6, the bottom folding mechanism 2 further includes symmetrically arranged second bottom connector 216 and third bottom connector 215. The lower end of the first suspension rod 71 and the lower end of the second suspension rod 72 are respectively connected to the second bottom connector 216 and the third bottom connector 215. The third bottom connecting tube 213 of the first bottom support assembly 21 and the third bottom connecting tube 213 of the second bottom support assembly 22 are rotatably connected at a limited angle to the third bottom connector 215. The fourth bottom connecting tube 214 of the first bottom support assembly 21 and the fourth bottom connecting tube 214 of the second bottom support assembly 22 are rotatably connected at a limited angle to the second bottom connector 216. The connection form is similar to that of the first bottom connector 210, except for the only difference that the mounting slots of the second bottom connector 216 and the third bottom connector 215 are open upward to restrict the third bottom connector 213 and the fourth bottom connector 214 such that they can only rotate downward relative to the mounting slots of the second bottom connector 216 and the third bottom connector 215 from the folded tilted state to the horizontal state. When the wagon needs to be folded, first, the two first bottom connectors 210 are driven to move upward. The four bottom connecting tubes connected to the corresponding first bottom connectors 210 rotate from the unfolded horizontal state to the tilted state. The bottom connecting tubes converge with each other, thereby driving the four standing posts 1 to converge with each other. The four standing posts 1 press the first folding mechanism 31, the third folding mechanism 33, the second folding mechanism 32, and the fourth folding mechanism 34 to fold. The first suspension rod 71 and the second suspension rod 72 deform, and the two ends of the first suspension rod 71 respectively approach the two ends of the second suspension rod 72.

As shown in FIGS. 1, 4, and 5, each of the third folding mechanism 33 and the fourth folding mechanism 34 includes first crossing tube 341 and second crossing tube 342 that are hinged to each other, as well as third crossing tube 343 and fourth crossing tube 344 that are hinged to each other. First ends of the first crossing tube 341 and the third crossing tube 343 are hinged to each other, and first ends of the second crossing tube 342 and the fourth crossing tube 344 are hinged to each other. In the fourth folding mechanism 34, a second end of the first crossing tube 341 is hinged to an upper end of the fourth standing post 14, and a second end of the third crossing tube 343 is hinged to an upper end of the first standing post 11. A second end of the second crossing tube 342 is hinged to the first sliding sleeve 41 on the fourth standing post 14, and a second end of the fourth crossing tube 344 is hinged to the first sliding sleeve 41 on the first standing post 11. In the third folding mechanism 33, a second end of the first crossing tube 341 is hinged to an upper end of the second standing post 12, and a second end of the third crossing tube 343 is hinged to an upper end of the third standing post 13. A second end of the second crossing tube 342 is hinged to the first sliding sleeve 41 on the second standing post 12, and a second end of the fourth crossing tube 344 is hinged to the first sliding sleeve 41 on the third standing post 13.

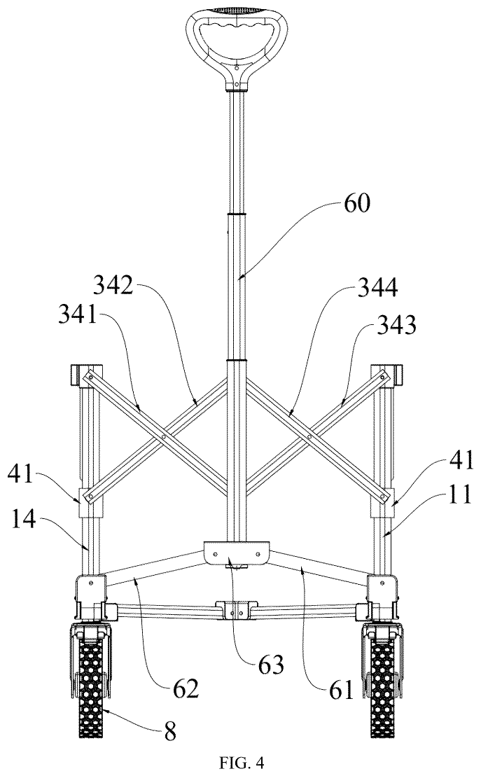

As shown in FIG. 1, the collapsible wagon further includes handle mechanism 6. Specifically, referring to FIG. 4, the handle mechanism 6 includes telescopic rod 60, first horizontal tube 61, second horizontal tube 62, and limiting member 63. The telescopic rod 60 is slidably connected to the limiting member 63. First ends of the first horizontal tube 61 and the second horizontal tube 62 are respectively rotatably connected to two ends of the limiting member 63. Specifically, the first end of the first horizontal tube 61 is rotatably connected to a first end of the limiting member 63, and the first end of the second horizontal tube 62 is rotatably connected to a second end of the limiting member 63. The first horizontal tube 61 and the second horizontal tube 62 are restricted by the limiting member 63 such that the first horizontal tube 61 and the second horizontal tube 62 can only rotate upward around the limiting member 63 from the folded tilted state to get close to the horizontal state or rotate downward around the limiting member 63 from the unfolded tilted state to get close to a vertical state. In the folding process, the first horizontal tube 61 and the second horizontal tube 62 rotate, and then the telescopic rod 60 slides downward, thereby reducing the height of the telescopic rod 60. Meanwhile, the telescopic rod 60 retracts, further reducing the height of the telescopic rod 60. Thus, the height of the handle mechanism 6 folded is not greater than the height of the standing post 1. The second ends of the first horizontal tube 61 and the second horizontal tube 62 are respectively rotatably connected to rotating components located at the lower ends of the first standing post 11 and the fourth standing post 14. A rotating shaft of the rotating component is perpendicular to rotating shafts of a first crossbar and a second crossbar. When the rotating component rotates, a free end of the telescopic rod 60 moves away from or close to the wagon. When the free end of the telescopic rod 60 moves away from the wagon, there is a certain angle between the telescopic rod 60 and a plane where the first standing post 11 and the fourth standing post 14 are located, which facilitates the user's dragging. A second end of the telescopic rod 60 is connected to a pull tab, further facilitating the user to drag the wagon. A caster 8 is provided at a lower end of each of the first standing posts 1. Preferably, the caster 8 provided at the lower end of each of the first standing post 11 and the fourth standing post 14 is a universal wheel, which facilitates the turning of the wagon.

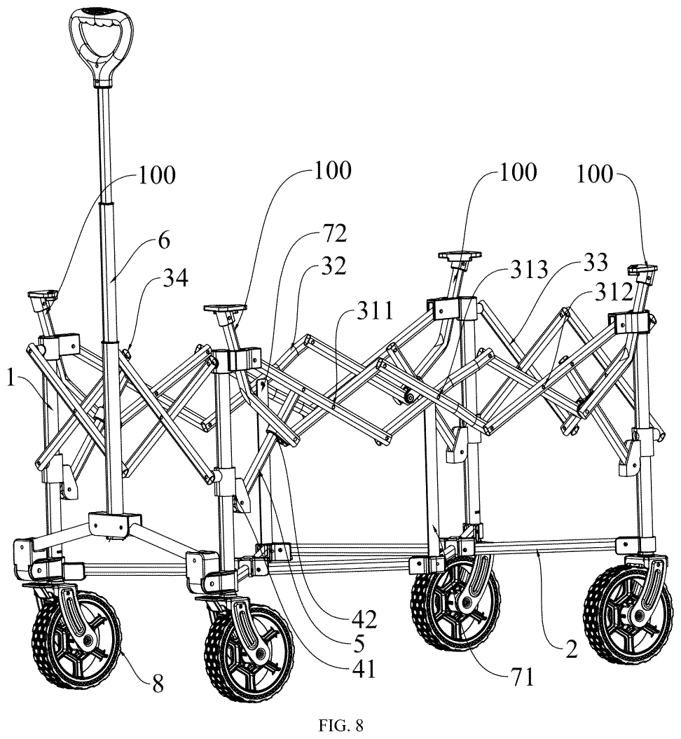

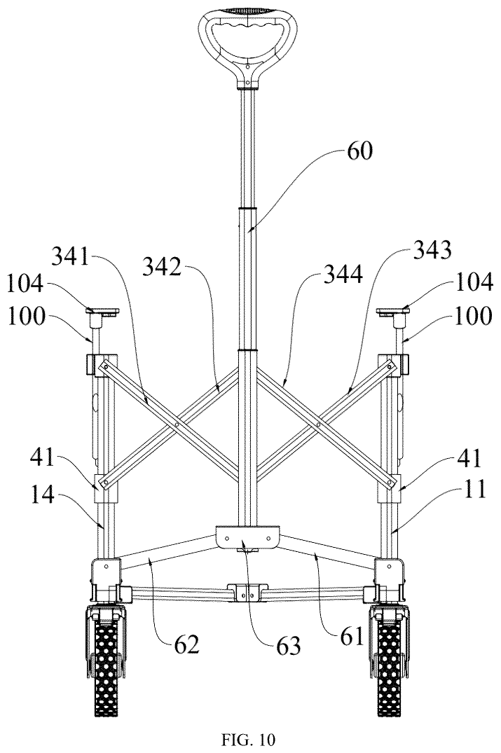

As shown in FIGS. 8 to 11, the present disclosure further provides a wagon with a height reduced after being folded, including lifting tubes and the above collapsible wagon. The structure of the collapsible wagon is shown in FIGS. 1 to 7. Each second sliding sleeve 42 of the collapsible wagon is hinged to one lifting tube 100, with a hinge point located at a lower end of the lifting tube 100. For example, in the connection structure between the first crossing assembly 311 and the lifting tube 100, the lower end of the lifting tube 100 is hinged to the second sliding sleeve 42 on the short tube 5 connected to the first crossing assembly 311, and a tube body of the lifting tube 100 is slidably connected to a top fixing element on the upper end of the first standing post 11. Upper ends of the four lifting tubes 100 are configured to be respectively connected to four corners of a fabric bed of the collapsible wagon. When the wagon changes from the unfolded state to the folded state, the upper ends of the lifting tubes 100 slide downward, thereby reducing the height of the collapsible wagon.

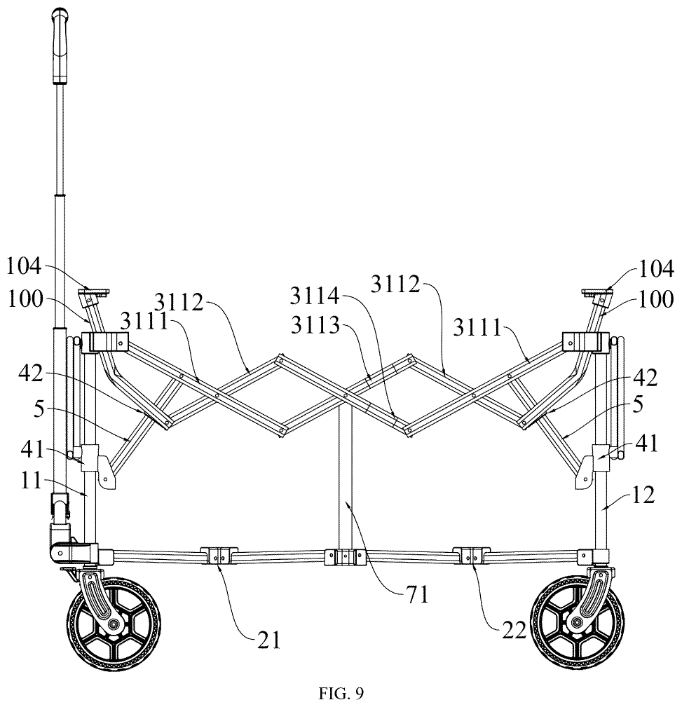

Referring to FIGS. 8 to 10, when the collapsible wagon changes from the folded state to the unfolded state, the upper ends of the lifting tube 100 move vertically away from the upper ends of the standing posts 1. The lifting tubes 100 lift a top of the fabric bed of the wagon upward to a height above the upper ends of standing posts 1, thereby increasing the overall height and capacity of the wagon. When the collapsible wagon changes from the unfolded state to the folded state, the upper ends of the lifting tubes 100 vertically approach the upper ends of the standing posts 1, such that the height of the collapsible wagon in the folded state is smaller than the height of the collapsible wagon in the unfolded state, and the height of the collapsible wagon is reduced after the collapsible wagon is folded. Specifically, to unfold the wagon, the upper ends of the lifting tubes 100 slide away from the upper ends of the standing posts 1. The unfolded state is shown in FIGS. 8 and 9, where the unfolded height of the wagon is greater than the folded height of the wagon, increasing the capacity of the wagon. To fold the wagon, the upper ends of the lifting tubes 100 slide down close to the upper ends of the standing posts 1. The folded state is shown in FIG. 11, where the folded height of the wagon is smaller than the unfolded height of the wagon. Therefore, the height of the wagon folded is reduced, thereby reducing the folded volume of the wagon and making it easy for the user to carry and store.

Furthermore, the upper ends of the lifting tubes 100 are respectively provided with connecting members 104, and the connecting members 104 are respectively connected to the corners of the fabric bed of the collapsible wagon.

It should be understood that in the description of the present disclosure, terms such as “first” and “second” are used merely for a descriptive purpose, and should not be construed as indicating or implying relative importance, or implicitly indicating the number of indicated technical features. Thus, features defined with “first” and “second” may explicitly or implicitly include one or more of the features. In the description of the present disclosure, the term “a plurality of” means two or more, unless otherwise specifically defined.

In the present disclosure, unless otherwise clearly specified, the terms “installation”, “interconnection”, “connection” and “fixation” are intended to be understood in a broad sense. For example, the “connection” may be a fixed connection, removable connection or integral connection; may be a mechanical connection or electrical connection; may be a direct connection or indirect connection using a medium; and may be a communication or interaction between two elements. Those of ordinary skill in the art may understand the specific meanings of the above terms in the present disclosure based on specific situations.

In the present disclosure, unless otherwise explicitly stipulated, “a first feature is above or below a second feature” may indicate that “the first and second features are in direct contact” or “the first and second features are in indirect contact through an intermediate feature”. In addition, when it is described that the first feature is “over”, “above” and “on” the second feature, it indicates that the first feature is directly or obliquely above the second feature, or simply indicates that the horizontal height of the first feature is greater than that of the second feature. When it is described that a first feature is “under”, “below” or “beneath” a second feature, it indicates that the first feature is directly or obliquely under the second feature or simply indicates that the horizontal height of the first feature is lower than that of the second feature.

In the description of this specification, the description with reference to the terms such as “one embodiment”, “some embodiments”, “embodiments”, “an example”, “a specific example” and “some examples” indicate that the specific features, structures, materials, or characteristics described with reference to the embodiment or example are included in at least one embodiment or example of the present disclosure. In this specification, the schematic expression of the above terms is not necessarily directed to the same embodiment or example. Moreover, the specific features, structures, materials, or characteristics described may be combined in a suitable manner in any one or more embodiments or examples. In addition, those skilled in the art may combine different embodiments or examples described in this specification and characteristics of the different embodiments or examples without any contradiction.

Although the embodiments of the present disclosure have been described above, it should be understood that the above embodiments are exemplary, and may not be construed as limitations to the present disclosure. A person of ordinary skill in the art may make various changes, modifications, replacements and variations on the above embodiments within the scope of the present disclosure.

1. A collapsible wagon, comprising four standing posts arranged in a rectangle pattern and at intervals, a bottom folding mechanism hinged between the four standing posts, a first folding mechanism, a third folding mechanism, a second folding mechanism, a fourth folding mechanism, and first sliding sleeves respectively slidably provided on the four standing posts, wherein the first folding mechanism, the third folding mechanism, the second folding mechanism and the fourth folding mechanism are arranged in sequence and respectively connected between adjacent two standing posts of the four standing posts, and each of the first sliding sleeves is hinged to a short tube;
each of the first folding mechanism and the second folding mechanism comprises a first crossing assembly, at least one third crossing assembly, and a second crossing assembly, wherein the first crossing assembly, the at least one third crossing assembly, and the second crossing assembly are hinged in sequence; each of the first crossing assembly and the second crossing assembly comprises a first cross tube and a second cross tube; the first cross tube is hinged to an upper end of the corresponding standing post, and the short tube is hinged to the first cross tube; the short tube is provided with a second sliding sleeve; and the second cross tube is hinged to the second sliding sleeve of the corresponding short tube; and
folded heights of the first crossing assembly, the at least one third crossing assembly, the second crossing assembly, the third folding mechanism, the fourth folding mechanism and the bottom folding mechanism are less than or equal to a height of the upper end of the standing post.

2. The collapsible wagon according to claim 1, wherein each of the first folding mechanism and the second folding mechanism comprises the first crossing assembly, the third crossing assembly, and the second crossing assembly, wherein the first crossing assembly, the third crossing assembly, and the second crossing assembly are hinged in sequence.

3. The collapsible wagon according to claim 1, further comprising a first suspension rod and a second suspension rod; wherein
an upper end of the first suspension rod is hinged to the first folding mechanism; an upper end of the second suspension rod is hinged to the second folding mechanism; and a lower end of the first suspension rod and a lower end of the second suspension rod are connected to the bottom folding mechanism; and
the first suspension rod and the second suspension rod are flexible rods; and in a process of folding the collapsible wagon, the first suspension rod and the second suspension rod deform, and the upper end and the lower end of the first suspension rod respectively approach the upper end and the lower end of the second suspension rod.

4. The collapsible wagon according to claim 3, wherein the bottom folding mechanism comprises a first bottom support assembly and a second bottom support assembly, wherein the first bottom support assembly and the second bottom support assembly are symmetrically arranged and hinged to each other; and each of the first bottom support assembly and the second bottom support assembly comprises a first bottom connector, a first bottom connecting tube, a second bottom connecting tube, a third bottom connecting tube, and a fourth bottom connecting tube;
first ends of the first bottom connecting tube, the second bottom connecting tube, the third bottom connecting tube and the fourth bottom connecting tube are rotatably connected at a first limited angle to the first bottom connector; and
second ends of the first bottom connecting tube and the second bottom connecting tube are respectively rotatably connected at a second limited angle to lower ends of corresponding standing posts.

5. The collapsible wagon according to claim 4, wherein the bottom folding mechanism further comprises a second bottom connector and a third bottom connector, wherein the second bottom connector and the third bottom connector are symmetrically arranged; and the lower end of the first suspension rod and the lower end of the second suspension rod are respectively connected to the second bottom connector and the third bottom connector;
the third bottom connecting tube of the first bottom support assembly and the third bottom connecting tube of the second bottom support assembly are rotatably connected at a third limited angle to the third bottom connector; and
the fourth bottom connecting tube of the first bottom support assembly and the fourth bottom connecting tube of the second bottom support assembly are rotatably connected at a fourth limited angle to the second bottom connector.

6. The collapsible wagon according to claim 1, wherein the four standing posts are a first standing post, a second standing post, a third standing post, and a fourth standing post, respectively;
each of the third folding mechanism and the fourth folding mechanism comprises a first crossing tube, a second crossing tube, a third crossing tube, and a fourth crossing tube, wherein the first crossing tube and the second crossing tube are hinged to each other, and the third crossing tube and the fourth crossing tube are hinged to each other; a first end of the first crossing tube and a first end of the third crossing tube are hinged to each other; and a first end of the second crossing tube and a first end of the fourth crossing tube are hinged to each other;
in the fourth folding mechanism, a second end of the first crossing tube is hinged to an upper end of the fourth standing post, a second end of the third crossing tube is hinged to an upper end of the first standing post, a second end of the second crossing tube is hinged to the first sliding sleeve on the fourth standing post, and a second end of the fourth crossing tube is hinged to the first sliding sleeve on the first standing post; and
in the third folding mechanism, a second end of the first crossing tube is hinged to an upper end of the second standing post, a second end of the third crossing tube is hinged to an upper end of the third standing post, a second end of the second crossing tube is hinged to the first sliding sleeve on the second standing post, and a second end of the fourth crossing tube is hinged to the first sliding sleeve on the third standing post.

7. The collapsible wagon according to claim 1, further comprising a handle mechanism; wherein
the handle mechanism comprises a telescopic rod, a first horizontal tube, a second horizontal tube, and a limiting member; and the telescopic rod is slidably connected to the limiting member; and
first ends of the first horizontal tube and the second horizontal tube are respectively rotatably connected at a limited angle to two ends of the limiting member; and second ends of the first horizontal tube and the second horizontal tube are respectively rotatably connected to lower ends of two standing posts connected to the fourth folding mechanism.

8. A wagon with a height reduced after being folded, comprising four lifting tubes and the collapsible wagon according to claim 1, wherein an end of each of the four lifting tubes is hinged to the second sliding sleeve, and each of the four lifting tubes is slidably connected to the upper end of the corresponding standing post; and upper ends of the four lifting tubes are configured to be respectively connected to four corners of a fabric bed of the wagon with the height reduced after being folded;
when the collapsible wagon changes from a folded state to an unfolded state, the upper ends of the four lifting tubes move vertically away from the upper ends of the four standing posts when a wagon frame is unfolded; and when the collapsible wagon changes from the unfolded state to the folded state, the upper ends of the four lifting tubes vertically approach the upper ends of the four standing posts when the wagon frame is folded; and
a height of the collapsible wagon in the folded state is smaller than a height of the collapsible wagon in the unfolded state, and the height of the collapsible wagon is reduced after the collapsible wagon is folded.

9. The wagon with the height reduced after being folded according to claim 8, wherein the upper ends of the four lifting tubes are respectively provided with connecting members, and the connecting members are respectively connected to the four corners of the fabric bed of the wagon with the height reduced after being folded.

10. The wagon with the height reduced after being folded according to claim 8, wherein in the collapsible wagon, each of the first folding mechanism and the second folding mechanism comprises the first crossing assembly, the third crossing assembly, and the second crossing assembly, wherein the first crossing assembly, the third crossing assembly, and the second crossing assembly are hinged in sequence.

11. The wagon with the height reduced after being folded according to claim 8, wherein the collapsible wagon further comprises a first suspension rod and a second suspension rod; wherein
an upper end of the first suspension rod is hinged to the first folding mechanism; an upper end of the second suspension rod is hinged to the second folding mechanism; and a lower end of the first suspension rod and a lower end of the second suspension rod are connected to the bottom folding mechanism; and
the first suspension rod and the second suspension rod are flexible rods; and in a process of folding the collapsible wagon, the first suspension rod and the second suspension rod deform, and the upper end and the lower end of the first suspension rod respectively approach the upper end and the lower end of the second suspension rod.

12. The wagon with the height reduced after being folded according to claim 11, wherein in the collapsible wagon, the bottom folding mechanism comprises a first bottom support assembly and a second bottom support assembly, wherein the first bottom support assembly and the second bottom support assembly are symmetrically arranged and hinged to each other; and each of the first bottom support assembly and the second bottom support assembly comprises a first bottom connector, a first bottom connecting tube, a second bottom connecting tube, a third bottom connecting tube, and a fourth bottom connecting tube;
first ends of the first bottom connecting tube, the second bottom connecting tube, the third bottom connecting tube and the fourth bottom connecting tube are rotatably connected at a first limited angle to the first bottom connector; and
second ends of the first bottom connecting tube and the second bottom connecting tube are respectively rotatably connected at a second limited angle to lower ends of corresponding standing posts.

13. The wagon with the height reduced after being folded according to claim 12, wherein the bottom folding mechanism further comprises a second bottom connector and a third bottom connector, wherein the second bottom connector and the third bottom connector are symmetrically arranged; and the lower end of the first suspension rod and the lower end of the second suspension rod are respectively connected to the second bottom connector and the third bottom connector;
the third bottom connecting tube of the first bottom support assembly and the third bottom connecting tube of the second bottom support assembly are rotatably connected at a third limited angle to the third bottom connector; and
the fourth bottom connecting tube of the first bottom support assembly and the fourth bottom connecting tube of the second bottom support assembly are rotatably connected at a fourth limited angle to the second bottom connector.

14. The wagon with the height reduced after being folded according to claim 8, wherein in the collapsible wagon, the four standing posts are a first standing post, a second standing post, a third standing post, and a fourth standing post, respectively;
each of the third folding mechanism and the fourth folding mechanism comprises a first crossing tube, a second crossing tube, a third crossing tube, and a fourth crossing tube, wherein the first crossing tube and the second crossing tube are hinged to each other, and the third crossing tube and the fourth crossing tube are hinged to each other; a first end of the first crossing tube and a first end of the third crossing tube are hinged to each other; and a first end of the second crossing tube and a first end of the fourth crossing tube are hinged to each other;
in the fourth folding mechanism, a second end of the first crossing tube is hinged to an upper end of the fourth standing post, a second end of the third crossing tube is hinged to an upper end of the first standing post, a second end of the second crossing tube is hinged to the first sliding sleeve on the fourth standing post, and a second end of the fourth crossing tube is hinged to the first sliding sleeve on the first standing post; and
in the third folding mechanism, a second end of the first crossing tube is hinged to an upper end of the second standing post, a second end of the third crossing tube is hinged to an upper end of the third standing post, a second end of the second crossing tube is hinged to the first sliding sleeve on the second standing post, and a second end of the fourth crossing tube is hinged to the first sliding sleeve on the third standing post.

15. The wagon with the height reduced after being folded according to claim 8, wherein the collapsible wagon further comprises a handle mechanism; wherein
the handle mechanism comprises a telescopic rod, a first horizontal tube, a second horizontal tube, and a limiting member; and the telescopic rod is slidably connected to the limiting member; and
first ends of the first horizontal tube and the second horizontal tube are respectively rotatably connected at a limited angle to two ends of the limiting member; and second ends of the first horizontal tube and the second horizontal tube are respectively rotatably connected to lower ends of two standing posts connected to the fourth folding mechanism.

16. The wagon with the height reduced after being folded according to claim 10, wherein the upper ends of the four lifting tubes are respectively provided with connecting members, and the connecting members are respectively connected to the four corners of the fabric bed of the wagon with the height reduced after being folded.

17. The wagon with the height reduced after being folded according to claim 11, wherein the upper ends of the four lifting tubes are respectively provided with connecting members, and the connecting members are respectively connected to the four corners of the fabric bed of the wagon with the height reduced after being folded.

18. The wagon with the height reduced after being folded according to claim 12, wherein the upper ends of the four lifting tubes are respectively provided with connecting members, and the connecting members are respectively connected to the four corners of the fabric bed of the wagon with the height reduced after being folded.

19. The wagon with the height reduced after being folded according to claim 13, wherein the upper ends of the four lifting tubes are respectively provided with connecting members, and the connecting members are respectively connected to the four corners of the fabric bed of the wagon with the height reduced after being folded.

20. The wagon with the height reduced after being folded according to claim 14, wherein the upper ends of the four lifting tubes are respectively provided with connecting members, and the connecting members are respectively connected to the four corners of the fabric bed of the wagon with the height reduced after being folded.
